(19) United States
(12) Patent Application Publication
(10) Pub. No.: US 2012/0072842 A1
(43) Pub. Date: Mar. 22, 2012

(54) APPARATUS FOR COOKING AND METHOD OF HELPING A USER TO COOK

(75) Inventors: Chun Pong Yuan, Hong Kong (CN); Mirjam Suzanne Wouters, Weesp (NL); Paul Neervoort, Boxtel (NL); Mayur Prabhakar Karnik, Ahmedabad (IN); Eun-hye Jee, New Territories (HK)

(73) Assignee: KONINKLIJKE PHILIPS ELECTRONICS N.V., EINDHOVEN (NL)

(21) Appl. No.: 13/321,919

(22) PCT Filed: Jun. 4, 2010
(86) PCT No.: PCT/IB10/52489

§ 371 Date: Nov. 22, 2011

(30) Foreign Application Priority Data
Jun. 5, 2009 (CN) 200910139299.8

(51) Int. Cl. G06F 3/048

(52) U.S. Cl. 715/719; 715/810

(57) ABSTRACT

The present invention provides an apparatus for cooking and a method of helping a user to cook by prompting the user, step by step, to carry out the corresponding preparation at the right time. The apparatus comprises a presenter, configured to present information with respect to a first preparation for a first operation; a detector, configured to detect whether said first preparation has been carried out; and a performer, configured to perform said first operation. By applying the apparatus and method of the present invention, the process of cooking is greatly simplified to users. Users no longer need to monitor the cooking process. All they need to do is carry out the corresponding preparations as prompted or guided.

### FIELD OF THE INVENTION

The invention relates to an apparatus for cooking; the invention also relates to a method of helping a user to cook.

### BACKGROUND OF THE INVENTION

People with a fast life style are increasingly eager to use smart cookers to simplify their cooking work. However, the currently available cookers only provide several simple cooking functions (steam, stew, double boiled etc.). When using such cookers, people still need to pay much attention to the process of cooking, such as when to add ingredients, when to turn down/off the heat source, etc.

### SUMMARY OF THE INVENTION

To eliminate the above disadvantages, the present invention provides a technical cooking solution by prompting the user, step by step, to carry out the corresponding preparation steps at the right time.

According to an embodiment of the present invention, there is provided an apparatus for cooking, comprising:

a presenter, configured to present information with respect to a first preparation for a first operation;

a detector, configured to detect whether said first preparation has been carried out;

a performer, configured to perform said first operation if said first preparation has been carried out.

In an embodiment, said presenter is further configured to present information with respect to a second preparation for a second operation;

said detector is further configured to detect whether said second preparation has been carried out;

said performer is further configured to perform said second operation if said second preparation has been carried out.

Alternatively, the presenter comprises a screen and/or a speaker. The screen is configured to display text and/or videos and/or pictures for presenting information with respect to said first or second preparation. The speaker is configured to produce sound for presenting information with respect to said first or second preparation.

According to another embodiment of the present invention, there is provided a cooker comprising the apparatus described above. Advantageously, the cooker is a rice cooker.

According to another embodiment of the present invention, there is provided a method of helping a user to cook, comprising:
presenting information with respect to a first preparation for a first operation;
detecting whether said first preparation has been carried out;
performing said first operation if said first preparation has been carried out.

Advantageously, the method of helping the user to cook further comprises the following steps:
presenting information with respect to a second preparation for a second operation;
detecting whether said second preparation has been carried out;
performing said second operation if said second preparation has been carried out.

By applying the apparatus and method of the present invention, the process of cooking is greatly simplified to users. Users no longer have to monitor the cooking process. All they have to do is carry out the corresponding preparations as prompted or guided. This means that various raw ingredients can be added into the apparatus selecting the right cooking time and delicious dishes can be made requiring much less attention from users.

Furthermore, as the prompt or guidance can be presented in text, audio or video format, people who don't know the recipe in advance can also prepare high quality dishes.

### DESCRIPTION OF THE DRAWINGS

The above and other objects and features of the present invention will become more apparent from the following detailed description considered in connection with the accompanying drawings, in which:

FIG. 1 is a schematic block diagram of an apparatus 100 according to an embodiment of the present invention;

FIG. 2 is a flowchart showing the function of the apparatus 100 in FIG. 1;

The same reference numerals are used to denote similar parts throughout the Figures.

### DETAILED DESCRIPTION

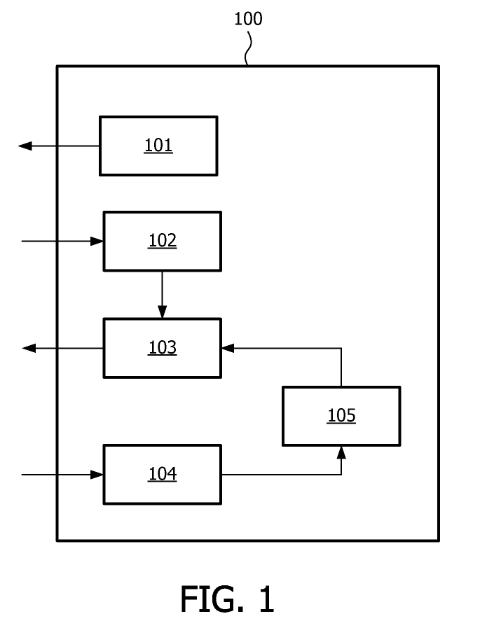

FIG. 1 shows a schematic block diagram of apparatus 100 for cooking according to an embodiment of the present invention. In FIG. 1, the apparatus 100 comprises a provider 101, a receiver 102, a presenter 103, a detector 104, a performer 105.

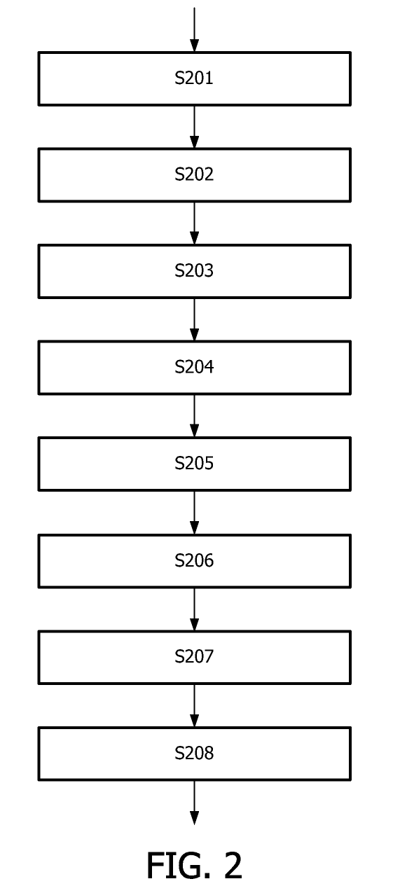

FIG. 2 shows a schematic flowchart of a cooking process of the apparatus 100 in FIG. 1, which will be described in detail in the following part of the text in conjunction with FIG. l.

Firstly, in step S201, the provider 101 provides a menu from which a user can make a selection. The menu can be provided by displaying text and/or pictures and/or videos on a screen, and/or producing sound via a speaker. The provider 101 can also be a set of buttons on the apparatus 100, similar to those used on conventional rice cookers. The menu can include a lot of dishes, such as Tom Yum soup, vegetable soup, meat ball soup, fish ball soup, rice, and congee etc.

Secondly, in step S202, the receiver 102 receives a menu selection from the user. Similarly, the user can make the selection by means of a text input, or button input, or voice input etc. Obviously, for the latter one, the receiver 102 should have a microphone and a corresponding speech processing module to receive the user's voice and recognize the meaning of the user's voice.

Alternatively, after the receiver 102 has received the selection from the user, the presenter 103 can first present a list of ingredients for preparation or a prescribed recipe associated with the dish the user has selected before step S203. For example, if the user chooses Tom Yum soup, a list of ingredients for the preparation of Tom Yum soup can be presented like: broth—4 cups, mushroom—5, tomato—1, kaffir lime leaves—3 pieces, glangal & lemon grass—1, shrimp/meat—1 cup, chili paste—1 spoon, other seasoning.

Then, in step S203, the presenter 103 presents information with respect to a first preparation for a first operation associated with a prescribed recipe for the dish the user has selected. It is to be understood that information with respect to the first preparation and the first operation vary due to the different dishes the user has selected. For example, for Tom Yum soup, information with respect to the first preparation is “add broth, mushrooms, tomato, kaffir lime leaves, galangal & lemon grass” and the first operation is “heating for half an hour”. For vegetable soup, information with respect to the first preparation is “add water to make broth” and the first operation is “heating the water to the boil”.

Then, in step S204, the detector 104 detects whether the first preparation has been carried out. There are various ways of detecting this. For example, the user can give feedback to indicate that the first preparation has been carried out. The detector 104 confirms that the first preparation has been carried out if it receives such feedback. Such feedback can be given in several ways. For example, the user can press a button (such as “Start” button or “Continue” or “OK” button) to give feedback or say some words like “Preparation is done” etc. For the former case, the detector 104 confirms the first preparation has been carried out when the pressure applied to the button is detected by the detector 104. For the latte case, similar to the receiver 102, the detector 104 should have a microphone and a corresponding speech processing module to receive the user's voice and recognize the meaning of the user's voice.

Alternatively, in some situations, the user need not give feedback. The detector 104 can detect the pressure produced by an accessory of the apparatus 100 (for example, the inner boiler of a rice cooker) to check if the first preparation such as introducing cooking ingredients has been carried out. Alternatively, the detector 104 can detect whether the cover has been opened and closed to determine if the first preparation has been carried out. Also, there are a lot of ways to detect the opening and closing of the cover, such as detecting the pressure produced by the cover, or using an ambient-light-sensor to detect whether the cover has been opened, etc.

If the detection result indicates that the first preparation has been carried out, the performer 105 performs the first operation in step S205. For Tom Yum soup, the first operation is heating the broth for half an hour. The performer 105 can use a timer to determine whether the cooking time is up. Advantageously, the cooking time of every operation can be manually adjusted by the user according to his/her personal taste. For vegetable soup, the first operation is heating the water to the boil. The performer 105 can use a thermometer or a hygrometer to determine if the water is boiling.

After the first operation has been carried out, the presenter 103 presents information with respect to a second preparation for a second operation in step S206. For Tom Yum soup, the presenter 103 presents “Add shrimp/meat”. For vegetable soup, the presenter 103 presents “Add vegetables”. For information with respect to every preparation, in addition to the ingredients, the quantity of the ingredients can be presented together, for example “Add shrimp/meat, 1 cup or 100 g”.

In addition to presenting information with respect to the second preparation, the presenter 103 can further present reminding information to remind the user that the first operation has been performed. For example, the presenter 103 can use a beeper or a buzzer to produce a beep, or play a short music message to remind the user that the first operation has been performed.

In step S207, the detector 104 detects whether the second preparation has been carried out. The way of detecting is similar to that in step S204.

If the second preparation has been carried out, the performer 105 performs the second operation in step S208. For example, for Tom Yum soup, the second operation is to continue heating for 6 minutes. For vegetable soup, the second operation is to continue heating to the boil again.

If other operations need to be performed, the presenter 103, the detector 104, the performer 105 performs the above procedures for said other operations.

For example, for Tom Yum soup, alternatively, there is a third operation of “keeping warm for one hour”. After the second operation of heating for 6 minutes, the presenter 103 presents information with respect to the third preparation of “Add chili paste & other seasoning”. The detector 104 then detects whether the third preparation has been carried out by means of a step similar to step S204. If the third preparation has been carried out, the performer 105 performs the third operation.

Alternatively, the presenter 103 can further present information referring to the status of the operation as “Done” after the performer 105 has performed the last operation associated with the prescribed recipe for the dish the user has selected. For example, the vegetable soup just comprises two operations; after the performer 105 has performed the second operation of heating the broth to the boil, the presenter 103 presents the status information “Done” to notify the user that the vegetable soup is ready. Alternatively, the presenter 103 can play music together with the status presentation “Done” via a speaker.

In view of the function of the apparatus as elucidated hereinabove in conjunction with FIG. 1 and FIG. 2, the working process of the apparatus 100 is a well-elaborated example of a cooking process including two or more operations. It is to be understood that the units in FIG. 1 and the flow in FIG. 2 are only for illustrative purposes. The hardware implementation of the apparatus 100 can be various. For example, the provider 101 and the presenter 103 can share the same hardware, such as a plurality of buttons, a screen, a speaker etc. As described above, the receiver 102 and the detector 104 can share the same hardware too.

It should be noted that the provider 101 and the receiver 102 are optional units. For example, an apparatus only for cooking one dish may not need the provider 101 and the receiver 102. For the same reason, steps S201 and S202 are optional steps too. In addition, steps S206 to S208 are also optional steps. For some dishes, the cooking process can comprise only a single operation. For example, in the case of steamed crab, information with respect to the first preparation, i.e. information with respect to the only preparation, can be “Add water and yellow wine, put the crab in the steamer”, and the first operation, i.e., the only operation can be “continue heating for fifteen minutes.

It is also to be understood that the above information with respect to preparation and operations is only illustrative. There can be several recipes for one dish in the menu. And operations performed by the performer 105 comprise various ways of cooking, such as heating, cooling, condensing or combinations thereof etc. The heating process can be implemented in many ways, such as stewing, steaming, barbecuing, frying and double boiling etc. The performer 105 can be a single utensil with multi-cooking function or a set of several utensils.

Another thing to be understood is that possibly many operations may have to be performed by the performer 105 for one dish. Such operations can be different from each other, or can be totally the same, or can be partially the same. Specifically, actions performed for one operation and for another operation can be different or the same, the materials targeted by the action of one operation and another operation can be different or the same, the time intervals of one operation and another operation can be different or the same. It can be seen from the above description that for Tom Yum soup, the action performed for the first operation is the same as that for the second operation, but the time interval associated with the first operation is different from that of the second operation.

Similarly to the operations, there also can be many preparations to be carried out by the user for one dish. Such preparations can be different from each other, or can be totally the same, or can be partially the same. For example, one cooking process of Chinese noodles is: 1. Pour water into the pot and heat it to the boil; 2. Add the noodles into the pot and then heat the water to the boil; 3. Add a bowl of cold water and heat the water to the boil; 4.Add another bowl of cold water and heat the water to the boil; 5. Keep it boiling for 3 minutes. From this recipe, it can be seen that the preparations of operation 3 and 4 are the same.

Traditional cookers may comprise the apparatus 100 to provide smart cooking solutions for the user. It is to be understood that various traditional cookers comprise electric cookers or gas cookers etc. The electric cooker can be a rice cooker or a microwave oven etc.

It should be noted that the above-described embodiments are for the purpose of illustration only and are not to be construed as a limitation of the invention. All modifications which do not depart from the spirit of the invention are intended to be included within the scope of the appended claims In the claims, any reference signs placed between parentheses shall not be construed as limiting the claim. The verb “to comprise” and its conjugations does not exclude the presence of elements or steps not listed in a claim or in the description. The word “a” or “an” preceding an element does not exclude the presence of a plurality of such elements. In the apparatus claims enumerating several units, several of these units can be embodied by one and the same item of hardware or software. The use of the words first, second, third, etc, does not indicate any ordering. These words are to be interpreted as names.

1. An apparatus (100) for cooking, comprising:
a presenter (103), configured to present information of a first preparation for a first operation;
a detector (104), configured to detect if said first preparation has been done;
a performer (105), configured to perform said first operation if said first preparation has been done.

2. An apparatus (100) according to claim 1, wherein, said presenter (103) is further configured to present information of a second preparation for a second operation;
said detector (104) is further configured to detect if said second preparation has been done;
said performer (105) is further configured to perform said second operation if said second preparation has been done.

3. An apparatus (100) according to claim 2, wherein said cooking comprises other operations besides said first and second operation, said presenter (103), said detector (104) and said performer (105) are further configured to do above procedures for other remaining operations until all operations for said cooking have been done.

4. An apparatus (100) according to claim 1, wherein said detector (104) is configured to:
detect if a feedback indicating said preparation has been done has been received.

5. An apparatus (100) according to claim 1, further comprising:
a provider (101), configured to provide a menu for selecting before said presenter (103) presenting information of said first preparation;
a receiver (102), configured to receive a selection in said menu.

6. An apparatus (100) according to claim 2, wherein said first operation is different from or same as said second operation.

7. An apparatus (100) according to claim 1, wherein said presenter (103) comprises at least one of the following:
a screen, configured to display text and/or videos and/or pictures for presenting information of said preparation;
a speaker, configured to play sounds for presenting information of said preparation.

8. A cooker, comprising an apparatus (100) as claimed according to claim 1.

9. A cooker according to claim 8, wherein said cooker is a rice cooker.

10. A method of helping a user to cook, comprising:
presenting (S203) information of a first preparation for a first operation;
detecting (S204) if said first preparation has been done;
performing (S205) said first operation if said first preparation has been done.

11. A method according to claim 10, further comprising:
presenting (S206) information of a second preparation for a second operation;
detecting (S207) if said second preparation has been done;
performing (S208) said second operation if said second preparation has been done.

12. A method according to claim 11, wherein said cooking comprises other operations besides said first and second operation, said method further comprises:
repeating said steps of presenting, detecting, performing for other remaining operations until all operations for said cooking has been done.

13. A method according to claim 10, wherein said step of detecting if said preparation has been done comprises:
detecting if a feedback indicating said preparation has been done has been received.

14. A method according to claim 10, wherein before said step of presenting (S203) information of said first preparation, said method further comprises:
providing (S201) a menu for selecting;
receiving (S202) a selection in said menu.

15. A method according to claim 10, wherein said step of presenting information of said preparation comprises at least one of the following:
presenting information of said preparation in form of displaying texts on a screen;
presenting information of said preparation in form of displaying videos or pictures on a screen;
presenting information of said preparation in form of playing sounds via a speaker.
